(19) United States
(12) Patent Application Publication
(10) Pub. No.: US 2007/0173289 A1
(43) Pub. Date: Jul. 26, 2007

(54) METHOD AND RELATED APPARATUS FOR ELIMINATING AN AUDIO SIGNAL COMPONENT FROM A RECEIVED SIGNAL HAVING A VOICE COMPONENT

(76) Inventors: Yen-Ju Huang, Taipei Hsien (TW); Wei-Nan William Tseng, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/307,166

(22) Filed: Jan. 26, 2006

(51) Int. Cl. H04B 1/38; H04M 1/00

(52) U.S. Cl. 455/563

(57) ABSTRACT

Audio signal processing includes encoding a first audio signal into a second audio signal according to a first code, outputting the first audio signal and the second audio signal from a speaker, and receiving a received signal with a microphone. The received signal includes a voice signal, third audio signal, and fourth audio signal. The voice signal is convolution of an original voice signal and the environment channel impulse response. The third audio signal is convolution of the first audio signal and the environment channel impulse response. The fourth audio signal is convolution of the second audio signal and the environment channel impulse response. Audio signal processing further includes encoding the received signal according to a second code conjugate to the first code, deriving the third audio signal from the encoded received signal, and deriving the original voice signal according to the first audio signal and the received signal.

### BACKGROUND OF THE INVENTION

1. Field of the Invention

The present invention relates to electronics, and more particularly, to audio processing circuitry.

2. Description of the Prior Art

As related technology keeps improving, various types of electronic devices are capable of executing functions according to an inputted voice command. For example, some mobile phones can make a phone call according to a name or a specific word spoken by a user. However, when an electronic device, such as an audio system is playing music, the played music signal or related audio signal outputted from a speaker of the audio system can interfere with a voice command from the user, such that the audio system is unable to recognize the original voice command.

Therefore, the audio system of the prior art cannot receive a clear voice command and execute functions according to the voice command while the audio system outputs music or other audio signal with the speaker.

### SUMMARY OF THE INVENTION

It is therefore an objective of the claimed invention to provide a method for eliminating an audio signal component from a received signal having a voice component in order to solve the problems of the prior art.

The present invention provides a method for obtaining an original voice signal from a received signal received from an environment with an environment channel impulse response, the received signal comprising a voice signal. The method comprises encoding a first audio signal into a second audio signal according to a first code; outputting the first audio signal and the second audio signal from a speaker; receiving a received signal with a microphone, the received signal comprising a voice signal, a third audio signal, and a fourth audio signal, wherein the voice signal is convolution of an original voice signal and the environment channel impulse response, the third audio signal is convolution of the first audio signal and the environment channel impulse response, and the fourth audio signal is convolution of the second audio signal and the environment channel impulse response; encoding the received signal to an encoded received signal according to a second code, wherein the second code and the first code are conjugate; deriving the third audio signal from the encoded received signal; and deriving the original voice signal at least according to the first audio signal and the received signal.

The present invention further provides an audio system used in an environment with an environment channel impulse response, the audio system comprising an outputting device and an inputting device. The outputting device comprises a first encoder for encoding a first audio signal into a second audio signal according to a first code; and a speaker coupled to the encoder for outputting the first audio signal and the second audio signal. The inputting device comprises a microphone for receiving a received signal comprising a voice signal, a third audio signal, and a fourth audio signal, wherein the voice signal is convolution of an original voice signal and the environment channel impulse response, the third audio signal is convolution of the first audio signal and the environment channel impulse response, and the fourth audio signal is convolution of the second audio signal and the environment channel impulse response; a second encoder for encoding the received signal to an encoded received signal according to a second code, in order to filter the third audio signal from the received signal, wherein the second code and the first code are conjugate; and a calculation unit coupled to the microphone and the audio filter for deriving the original voice signal at least according to the first audio signal and the received signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing an audio system of the present invention receiving a voice command from a user.

FIG. 2 is a diagram showing the spread-spectrum code of the present invention spreading a bandwidth of an original audio signal.

FIG. 3 is a functional block diagram of the calculation unit in FIG. 2.

FIG. 4 is a flowchart showing a method of the present invention.

FIG. 5 is a diagram showing the audio system of the present invention sending out a training signal.

FIG. 6 is a diagram showing the audio system of the present invention receiving a voice command from the user.

### DETAILED DESCRIPTION

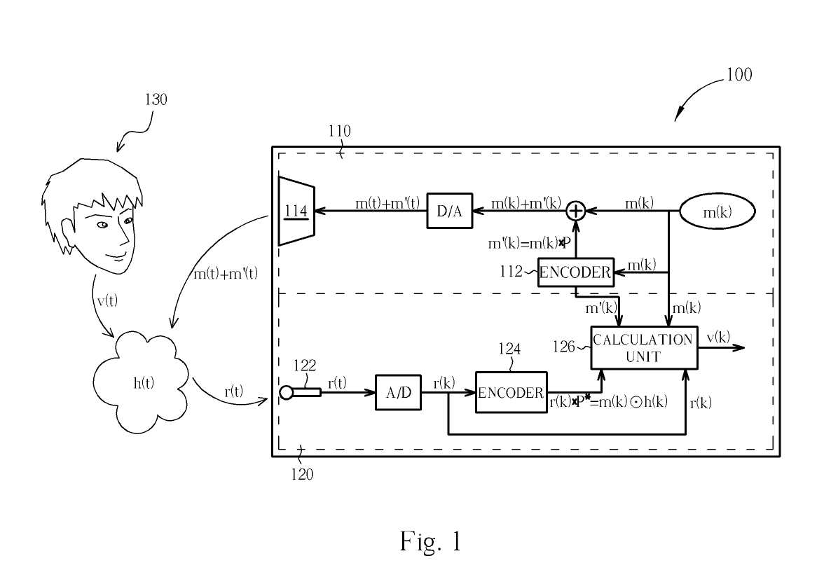

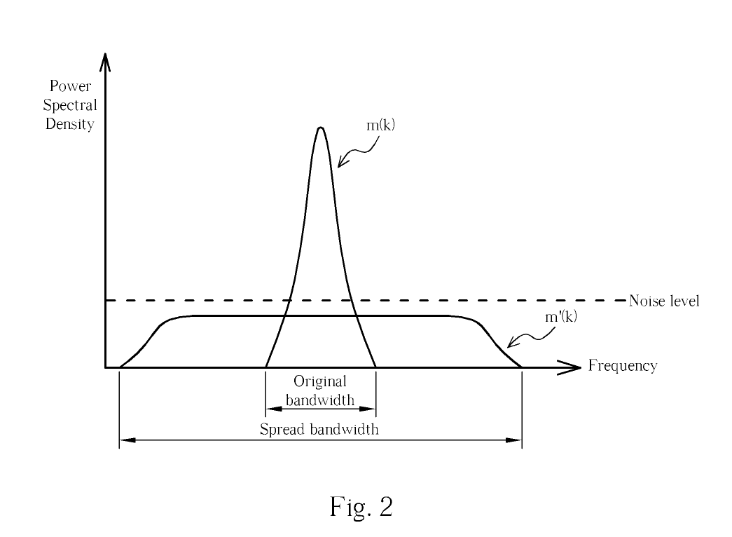

Please refer to FIG. 1, which shows an audio system 100 of the present invention receiving a voice command v(t) from a user 130. The audio system 100 of the present invention comprises an outputting device 110 and an inputting device 120. The outputting device 110 comprises a first encoder 112 and a speaker 114, and the inputting device 120 comprises a microphone 122, a second encoder 124, and a calculation unit 126. The encoder 112 encodes an original audio signal m(k) into an encoded audio signal m′(k) according to a transmitting code (first code) P. For example, the original audio signal m(k) could be a music signal, and the transmitting code P could be a spread-spectrum code. As shown in FIG. 2, the original audio signal m(k) is encoded with the spread-spectrum code P, so that bandwidth of encoded audio signal m′(k) is wider in frequency compared to that of original audio signal m(k), and a power level of the encoded signal m′(k) falls around a noise level which the human ear cannot hear. Thereafter, the digital audio signal m(k) and encoded signal m′(k) are converted into the analog format m(t) (first audio signal ) and m′(t) (second audio signal ) by a D/A converter, and then outputted by the speaker 114.

Because a voice signal is transmitted through air, an environment effect must be considered. Therefore every voice signal must be convoluted with a environment channel impulse response h(t). When an original voice signal v(t) (e.g. a voice command) is send out to the environment, the microphone receives a received signal r(t) comprising a third audio signal component m₃(t), a fourth audio signal component m₄(t), and a voice signal component v′(t). Component m₃(t) is convolution of the first audio signal m(t) and the environment channel impulse response h(t), component m₄(t) is convolution of the second audio signal m′(t) and the h(t), and component v′(t) is convolution of the original voice signal v(t) and the environment channel impulse response h(t) in the time domain. The received signal r(t) can be represented as the equation below:
r(t)=v(t)⊙h(t)+[m(t)+m′(t)]⊙h(t) (1)

The symbol ⊙ means convolution.

Thereafter, the analog received signal r(t) is converted into the digital format r(k) by an A/D converter. The related equation is shown below:
r(k)=v(k)⊙h(k)+[m(k)+m′(k)]⊙h(k) (2)

Then the received signal r(k) is encoded with a spread-spectrum code P* (second code), which is conjugate to the spread-spectrum code P. In this way some signal components will be recovered and separated from other signal components. More details will be described as follows. The related equation of encoded received signal is shown below:

$$\begin{matrix}r ( k ) \times {P}^{*} = [ {v}^{′} ( k ) + {m}_{3} ( k ) + {m}_{4} ( k ) ] \times {P}^{*} \\ = v ( k ) ⊙ h ( k ) \times {P}^{*} + [ m ( k ) ⊙ h ( k ) + {m}^{′} ( k ) ⊙ h ( k ) ] \times {P}^{*} \\ . . = {m}^{′} ( k ) ⊙ h ( k ) \times {P}^{*} \\ = [ m ( k ) \times P ] ⊙ h ( k ) \times {P}^{*} \\ = m ( k ) ⊙ h ( k )\end{matrix} \qquad ( 3 )$$

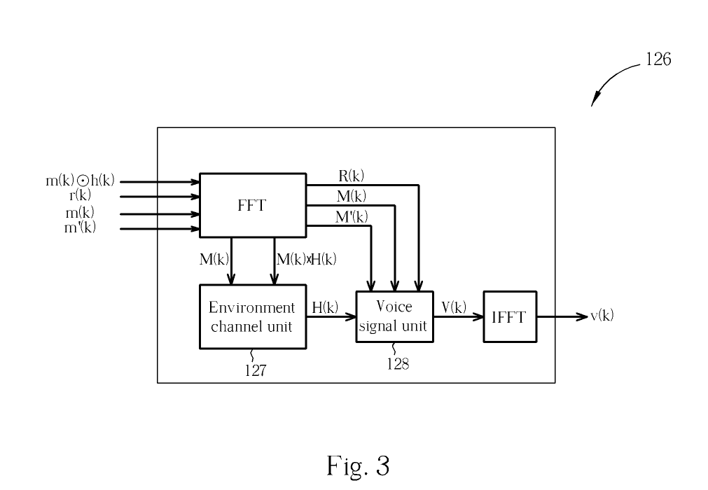

In equation (3), both the bandwidths of the received signal v(k) and m(k) are spread to wider bandwidths with the power levels falling around the noise level. However, because the spread-spectrum code P* is conjugate to the spread-spectrum code P, the received signal m′(k) is recovered to the bandwidth and power level which approximate to those of the original audio signal m(k). Power levels of components v(k)⊙h(k)×P* and m(k) ⊙h(k)×P* are much smaller than that of m′(k)⊙h(k)×P*, therefore, components v(k)⊙h(k)×P* and m(k)⊙h(k)×P* are ignored. After filtering the original audio signal component m(k) with the environment channel impulse response h(k) from the voice signal r(k), the calculation unit 126 can derive from the received voice signal r(k) to obtain the voice command component v(k). Please refer to FIG. 3, where a functional block diagram of the calculation unit 126 in FIG. 2 is illustrated. The audio eliminator 126 comprises a Fast Fourier Transform processor FFT, an environment channel unit 127, a voice signal unit 128, and an Inverse Fast Fourier Transform processor IFFT. The Fast Fourier Transform processor FFT transforms time domain signal to frequency domain signal in order to facilitate calculation. Thus the inputted signal r(k), m(k), m′(k), and m(k)⊙h(k) of the calculation unit 126 become R(K), M(K), M′(K), and M(K)×H(K) respectively. In the environment channel unit 127, the environment channel impulse response H(K) can be obtained according to signals M(K)×H(K) and M(K). The related equation is shown below:
H(K)=[M(K)×H(K)]/M(K) (4)

In the voice signal unit 128, because the signals R(K), M(K), M′(K) and the environment channel impulse response H(K) are already known, the voice command component V(K) can be further obtained. The related equation is shown below:
V(K)={R(K)−[M(K)+M′(K)]×H(K)}/H(K) (5)

Thereafter, the voice command component V(K) is transformed to the time domain format v(k) in the Inverse Fast Fourier Transform processor IFFT. The signal v(k) is the pure voice command with reduced interference from the original audio signal m(k). Therefore, the audio system 100 can precisely recognize the voice command v(k), and execute functions according to the voice command v(k).

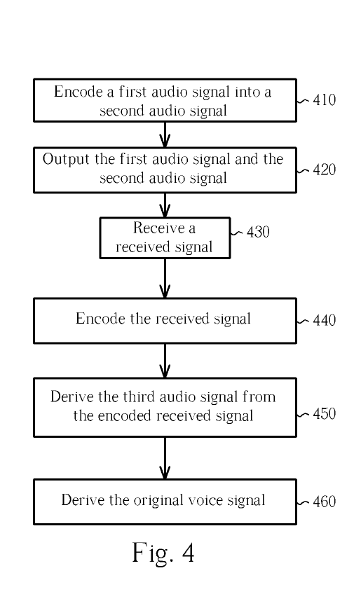

To more clearly illustrate the method for eliminating an audio signal component from a received voice signal having a voice command component, FIG. 4 provides a flowchart 400 of a method of the present invention. Please refer to FIG. 4, and refer to FIG. 2 and FIG. 3 as well. The flowchart 400 comprises the following steps:

Step 410: Encode a first audio signal into a second audio signal according to a first code;

Step 420: Output the first audio signal and the second audio signal from a speaker;

430: Receive a received signal with a microphone, wherein the received signal comprises a third audio signal, a fourth audio signal, and a voice signal;

Step 440: Encoding the received signal to an encoded received signal according to a second code conjugate to the first code;

Step 450: Derive the third audio signal from the encoded received signal;

Step 460: Derive the original voice signal at least according to the first audio signal and the received signal.

Basically, to achieve the same result, the steps of the flowchart 400 need not be in the exact order shown and need not be contiguous, that is, other steps can be intermediate.

However, removing the environment channel impulse response h(k) from the voice signal v′(k) is not always necessary. In a second embodiment, after encoding the received signal r(k) with the spread-spectrum code P* (second code) to obtain the third audio signal m₃(k) according to equation (3), the audio system 100 can directly eliminating the third audio signal m₃(k) from the received signal r(k) to obtain the voice signal component v′(k), The equation is shown below:

$$\begin{matrix}r ( k ) - {m}_{3} ( k ) = [ v ( k ) ⊙ h ( k ) + m ( k ) ⊙ h ( k ) + {m}^{′} ( k ) ⊙ h ( k ) ] - m ( k ) ⊙ h ( k ) \\ = v ( k ) ⊙ h ( k ) + {m}^{′} ( k ) ⊙ h ( k ) \\ . . = v ( k ) ⊙ h ( k ) \\ = {v}^{′} ( k )\end{matrix} \qquad ( 6 )$$

In equation (6), power levels of component m′(k)⊙h(k) is much smaller than that of v(k)⊙h(k), therefore, components m′(k)⊙h(k) is ignored. If there is no big interference in the environment, the audio system 100 can directly recognize the voice command v(k) from the voice signal v′(k). Therefore, the step of removing the environment channel impulse response h(k) from the voice signal v′(k) is not required.

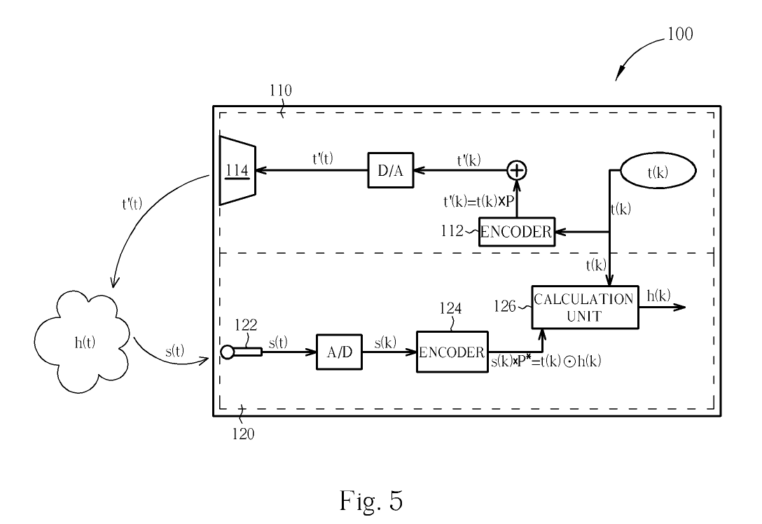

In a third embodiment, the audio system 100 can send a training signal t(k) in order to derive the environment channel impulse response first, and then derive the original voice signal according to the received signal and the first audio signal. For example, as shown in FIG. 5, the first encoder 112 encodes the training signal t(k) according to the first code P, and the analog encoded training signal t′(t) is outputted to the environment from the speaker 114. Thereafter the microphone 122 receives the feedback signal s(t), which is convolution of the encoded training signal t′(t) and the environment channel impulse response h(t). The feedback signal s(t) can be represented as the equation below:
s(t)=t′(t)⊙h(t) (7)

Then the digital feedback signal s(k) is encoded with the second code P*, same as the first embodiment, the second code P* is conjugate to the first code P, therefore the equation is shown below:

$$\begin{matrix}s ( k ) \times {P}^{*} = [ {t}^{′} ( k ) ⊙ h ( k ) ] \times {P}^{*} \\ = [ t ( k ) \times P ] ⊙ h ( k ) \times {P}^{*} \\ = t ( k ) ⊙ h ( k )\end{matrix} \qquad ( 8 )$$

Therefore, the environment channel impulse response H(k) can be obtained by dividing the encoded feedback signal by the training signal T(k) in the calculation unit 126. The equation is shown below:
h(K)=[t(K)×h(K)]/t(K) (9)

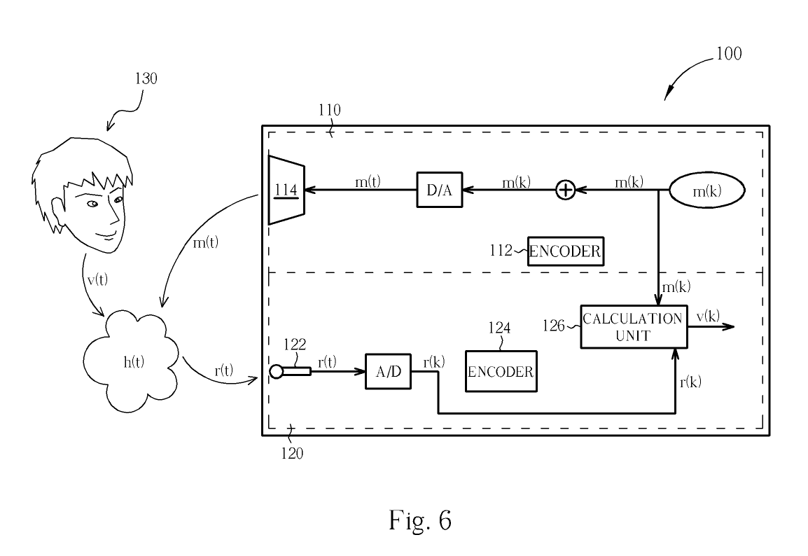

After obtaining the environment channel impulse response h(k), the audio system 100 can receive the original voice signal v(t) clearly while the audio system 100 outputs the audio signal m(k). As shown in FIG. 6, when the audio system 100 outputs the first audio signal m(t) from the speaker 114, the microphone 122 receives the received signal r(t) correspondingly. The received signal r(t) comprises a voice signal component v′(t) and a third audio signal component m₃(t), wherein the voice signal component v′(t) is convolution of the original voice signal v(t) and the environment channel impulse response h(t), and the third audio signal component m₃(t) is convolution of the first audio signal m(t) and the environment channel impulse response h(t) in the time domain. The received signal r(t) can be represented as the equation below:
r(t)=v′(t)+m₃(t)
=v(t)⊙h(t)+m(t)⊙h(t) (10)

Because the environment channel impulse response h(k) is already known, as well as the first audio signal m(t), the calculation unit 126 can easily derive the original voice signal v(k) according to the received signal r(k) and the first audio signal m(k). The equation is shown below:
v(k)=[r(k)/h(k)]−m(k) (11)

Therefore, the audio system 100 can precisely recognize the voice command v(k), and execute functions according to the voice command v(k).

Summarizing the above, the present invention provides a method for eliminating an audio signal component from a received signal having a voice command component, in order to receive a clear voice command without any interference according to the outputted audio signal.

In contrast to the prior art, the present invention is able to recognize the voice command v(t) from the user 130 clearly, and the audio system 100 (or related devices) of the present invention can execute functions according to the voice command v(t) from the user 130 while the audio system 100 outputs music or other audio signals with the speaker 114.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for obtaining an original voice signal from a received signal received from an environment with an environment channel impulse response, the received signal comprising a voice signal, the method comprising:
encoding a first audio signal into a second audio signal according to a first code;
outputting the first audio signal and the second audio signal from a speaker;
receiving a received signal with a microphone, the received signal comprising a voice signal, a third audio signal, and a fourth audio signal, wherein the voice signal is convolution of an original voice signal and the environment channel impulse response, the third audio signal is convolution of the first audio signal and the environment channel impulse response, and the fourth audio signal is convolution of the second audio signal and the environment channel impulse response;
encoding the received signal to an encoded received signal according to a second code, wherein the second code and the first code are conjugate;
deriving the third audio signal from the encoded received signal; and
deriving the original voice signal at least according to the first audio signal and the received signal.

2. The method of claim 1, wherein the first audio signal is a music signal.

3. The method of claim 1, wherein the first code is a spread-spectrum code.

4. The method of claim 1, wherein deriving the original voice signal comprises:
obtaining the environment channel impulse response by operation of the first audio signal and the third audio signal.

5. The method of claim 4, wherein the deriving the original voice signal further comprises:
obtaining the original voice signal by calculation of the received signal with first audio signal, the second audio signal, and the environment channel impulse response.

6. An audio system used in an environment with an environment channel impulse response, the audio system comprising:
an outputting device comprising:
a first encoder for encoding a first audio signal into a second audio signal according to a first code; and
a speaker coupled to the encoder for outputting the first audio signal and the second audio signal; and
an inputting device comprising:
a microphone for receiving a received signal comprising a voice signal, a third audio signal, and a fourth audio signal, wherein the voice signal is convolution of an original voice signal and the environment channel impulse response, the third audio signal is convolution of the first audio signal and the environment channel impulse response, and the fourth audio signal is convolution of the second audio signal and the environment channel impulse response;
a second encoder coupled to the microphone for encoding the received signal to an encoded received signal according to a second code, in order to filter the third audio signal from the received signal, wherein the second code and the first code are conjugate; and
a calculation unit coupled to the microphone and the audio filter for deriving the original voice signal at least according to the first audio signal and the received signal.

7. The audio system of claim 6, wherein the first audio signal is a music signal.

8. The audio system of claim 6, wherein the first code is a spread-spectrum code.

9. The audio system of claim 6, wherein the calculation unit comprises:
an environment channel unit for deriving the environment channel impulse response.

10. The audio system of claim 9, wherein the calculation unit further comprises:
a voice signal unit coupled to the environment channel unit for obtaining the original voice signal by calculation of the received signal with first audio signal, the second audio signal, and the environment channel impulse response.

11. A method for obtaining an original voice signal from a received signal received from an environment with an environment channel impulse response, the method comprising:
outputting a first audio signal from a speaker;
receiving the received signal with the microphone, the received signal comprising a third audio signal and a voice signal, wherein the third audio signal is convolution of the first audio signal and the environment channel impulse response, and the voice signal is convolution of the original voice signal and the environment channel impulse response; and
deriving the original voice signal according to the received signal and the first audio signal.

12. The method of claim 11 further comprising deriving the environment channel impulse response.

13. The method of claim 12, wherein deriving the environment channel impulse response comprising:
encoding the first audio signal into a second audio signal according to a first code;
outputting the second audio signal from a speaker;
receiving a fourth audio signal with a microphone, wherein the fourth audio signal is convolution of the second audio signal and the environment channel impulse response;
encoding the fourth audio signal according to a second code, wherein the second code and the first code are conjugate; and
deriving the environment channel impulse response by dividing the encoded fourth audio signal by the first audio signal.

14. The method of claim 11, wherein the first audio signal is a music signal.

15. The method of claim 13, wherein the first code is a spread-spectrum code.

16. A method for obtaining a voice signal from a received signal received from an environment, the received signal comprising a voice signal, the method comprising:
encoding a first audio signal into a second audio signal according to a first code;
outputting the first audio signal and the second audio signal from a speaker;
receiving a received signal with a microphone, the received signal comprising a voice signal, a third audio signal, and a fourth audio signal, wherein the third audio signal and the fourth audio signal is corresponding to the first audio signal and the second audio signal outputted from the speaker respectively;
encoding the received signal to an encoded received signal according to a second code in order to deriving the third audio signal from the encoded received signal, wherein the second code and the first code are conjugate; and
deriving the voice signal by eliminating the third audio signal from the received signal.

17. The method of claim 16, wherein the first audio signal is a music signal.

18. The method of claim 16, wherein the first code is a spread-spectrum code.
